(19) United States
(12) Patent Application Publication
(10) Pub. No.: US 2009/0277753 A1
(43) Pub. Date: Nov. 12, 2009

(54) DEVICE FOR CONVEYING ISOLATED FIELDS

(75) Inventor: Philippe Violle, Eguilles (FR)

Correspondence Address: YOUNG & THOMPSON, 209 Madison Street, Suite 500, ALEXANDRIA, VA, 22314, US

(73) Assignee: NEOLUTION, Brignals (FR)

(21) Appl. No.: 11/910,412

(22) PCT Filed: Mar. 30, 2006
(86) PCT No.: PCT/FR06/00686

§ 371 Date: Oct. 1, 2007

(30) Foreign Application Priority Data
Mar. 30, 2005 (FR) 0503079

(51) Int. Cl. B65G 15/22; B65G 21/10

(52) U.S. Cl. 198/586

(57) ABSTRACT

A device includes an assembly of conveying modules (3). Each of the conveying modules (3) is made up of a frame (1), a continuous handling conveyor, height and inclination adjusting element (18) and (2), and mechanical and electrical linking element (8) and (13) enabling the different modules to be linked so as to form a route capable of causing the transported loads to follow straight and/or curved trajectories with adjustable inclination.

The present invention concerns a device for conveying isolated loads comprising an assembly of conveying modules, portable and hinged together so as to form a multidirectional path for the transport and accumulation of isolated loads.

It concerns the industrial field of manufacturing material for continuous handling (mechanized) of isolated loads (parcels, tubs, boxes, bundles or any other type of unit loads). It is intended to be provided in all facilities processing flows of merchandise (warehouses, sorting centers, logistical centers, cargo terminals, etc.).

Currently, the equipment used for conveying flows in such facilities are apparatuses devoted to one function, provisioned to be suitable for a circuit form (example: a straight part cannot be configured as a curved part, a flat part cannot be bent, etc.).

The design of these apparatuses has been refined as much as possible to reduce costs, to the detriment of their versatility.

There are straight conveyor belts, curved conveyor belts, some elements which go uphill while other elements go downhill, etc. and their mechanical structure intrinsically prevents them from changing functions.

Generally, the manufacturer or logistician who invests in the acquisition of an automated handling circuit must modify its shape in the short- or middle-term, as the original application evolves very quickly. Conveyor sections must then be modified to be reused in a different configuration, which creates additional costs and potential technical problems as well as implementation delays. Often, new equipment must be acquired to complete the reused equipment.

If a new sudden and/or temporary handing need arises, users must make do with the means at their disposal, which generally means manual handling or handling with inappropriate resources, involving a significant decrease in productivity and a degradation of working conditions.

This phenomenon has become less acceptable over time, where several new factors have appeared:

the marketing constraints of user companies involve a greater variety of product packaging (commercial promotions, many and varied packaging formats, frequent changes in packaging . . . );

logistical functions (receipt, stocking, order preparation, shipping) as well as packaging and manufacturing conditions (co-packing, co-manufacture) are increasingly sub-contracted by user companies to outside service providers. These providers therefore must sometimes handle flows of merchandise for several different user clients. The continuous handling equipment must be able to process products with very different dimensions in these cases as well;

the lifespan of products and distribution networks decreases, which requires frequent modification of logistical structures;

the decrease of stocks leads to flow tension: it is beneficial to be able to add or move handling equipment very quickly making it possible to facilitate, accelerate or improve the processing of flows.

This leads to a demand by users for universal and flexible mechanized handling means.

This results in the interest of accumulating different functions with only one equipment item:

be configurable in straight AND curved AND/OR inclined parts

transport AND accumulate,

adapt to very variable work levels,

and to complete these new requirements with:

rapid deployment when a specific need arises,

real ease of implementation,

direct implementation by the user without resorting to specialized services (mechanical assembly, electrical cabling, automatism, . . . ), generally sub-contracted.

The device according to the present invention aims to resolve these drawbacks.

According to one aspect of the invention, each of the conveyor modules is made up of a frame, a continuous handling conveyor, height and inclination adjusting means, and mechanical and electrical linking means enabling the various modules to be linked so as to form a route capable of causing the transported loads to follow straight and/or curved trajectories with adjustable inclination.

According to another aspect of the invention, the device for conveying isolated loads comprises a support carriage for the conveyor modules and/or electrical power for them.

According to another aspect of the invention, each conveyor module is provided with transfer means between modules for loads to be transported following a curved trajectory.

According to another aspect of the invention, each conveyor module is provided with guide means (5, 7) for the loads to be transported.

According to another aspect of the invention, the height and inclination adjusting means are made using a system of telescopic and retractable bipods, each comprising blocking means which are angular and above said bipod.

According to another aspect of the invention, the angular blocking means above each bipod are made through the combination, on one hand, of an eccentric handle, four toothed rings, a horizontal tie rod, all positioned to as to angularly block the bipods relative to the frame, and, on the other hand, two control cones, two vertical tie rods, four vertical posts, and two ring springs, positioned so as to block the height adjusting movement of the bipods.

According to another aspect of the invention, the additional height and inclination adjusting means are of the simple shear type.

According to another aspect of the invention, the mechanical means enabling the different modules to be linked comprises telescopic expansion means with a ball link, the latter means being positioned so as to be able to form a conveyor angle between the modules which is variable on several planes.

According to another aspect of the invention, the telescopic expansion means are adjustable without tools, by a 90° rotation of the ball joint or of the yoke around their axes.

According to another aspect of the invention, the transfer means between modules of the transported loads comprises a conical roller, motorized thanks to a counter-roller bearing on the rotating part of the conveyor, said conical roller being implemented so as to cause the transported loads to follow a curved trajectory and being mounted on a telescopic support enabling adaptation to different gap lengths caused by the configuration of the installation: straight part towards another straight part, straight part towards curved part, curved part towards curved part.

According to another aspect of the invention, the guide means for the transported loads comprise guide edges, made up of a malleable tube in a plastic or other material, fixed on a mechanical or magnetic support, and positioned so as to prevent the transported products from falling on the ground.

According to another aspect of the invention, the mechanical and electrical linking means are mounted on conveyors so as to be able to retransmit the information signals as well as the electrical power needed to connect another conveyor module located after a traditional conveyor, so as to be able to insert traditional conveyors within a circuit made up of conveyor modules according to the present invention.

According to another aspect of the invention, each conveyor module is designed to be portable and to be set up without tools, by just one person.

The device according to the invention makes it possible, among other things, to implement quickly, easily and directly by the user, a set of motorized and portable conveyor modules, making it possible to transport and/or accumulate a flow of isolated loads, by forming, according to the chosen route, parts which are straight, curved, rising, horizontal, descending, or a combination thereof.

The mechanical and electrical connection of the different conveyor modules is done quickly and without tools. All of the actions needed to configure or reconfigure the network of portable conveyors can be taken by just one person, man or woman.

The lightness and ease of use of each of the conveyor modules enables the user to use the equipment without delay and as frequently as possible, which, on one hand, increases the daily productivity of production centers and, on the other hand, decreases fatigue related to manual and periodic handling of unit loads.

Moreover, the object of the present invention can cover a large field of applications, contrary to the conveyors known to date. With the same device, it is possible to instantly modify the shape of a conveyor network in case of breakdown of a production machine, for example, to quickly add a work station, to load and unload vehicles (trucks, wagons, . . . ), to transport flows to a higher or lower level (platform, basement, . . . ). Many other applications are also possible.

The device according to the invention may also render all conveyor networks capable of evolving and being reconfigured. It is indeed possible to significantly change the route of the conveyor network without calling on specialized service providers (fitters, cable installers, computer specialists, . . . ), which is not the case for conveyors according to the existing technology.

The conveyor modules can be connected mechanically and electrically to conveyors of traditional technology which must be provided with compatible interfaces. The traditional conveyor is then used to transmit electrical power and control signals to the following conveyor module. The interest is in being able to mix, in a conveyor circuit, sections intended not to evolve structurally (using conveyors of the traditional technology) and those which are subject to frequent changes (using the conveyor modules according to the present invention).

The use of the object of the invention may therefore be generalized for a large number of applications for conveying isolated loads.

A set of photoelectric cells and electrical control cards, loaded on the conveyor, grant the system an accumulation function without pressure, meaning that the various conveyors are controlled according to the occupation status of the following conveyor. Thanks to this type of operation, the different isolated loads do not come into contact with each other, thereby avoiding the risk of degradation or falling to the ground. This function may be overridden for a traditional conveyor (without accumulation) by simply reconfiguring the paths of the control card.

A support and electrical power carriage completes the device according to the invention. The electrical power provided on the carriage is removable and can be brought alone in proximity to any of the portable conveyors when size constraints do not allow access by the carriage.

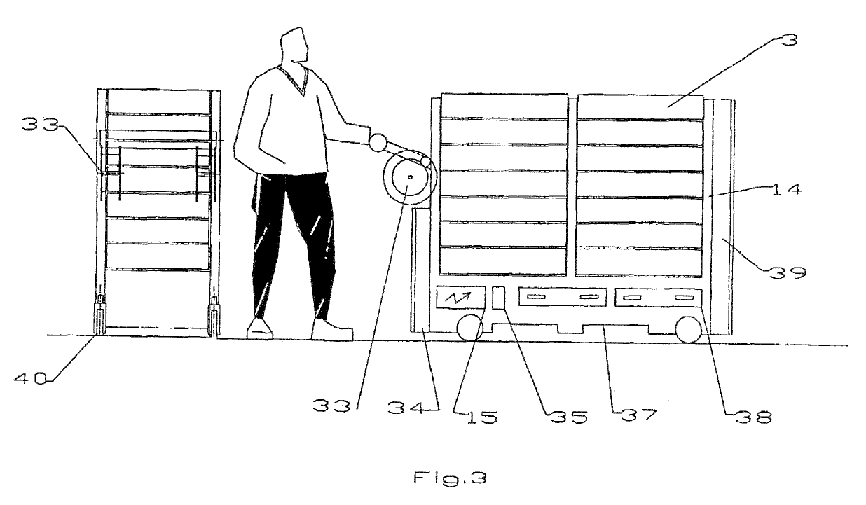

Moreover, the power carriage allows optimal stocking of 1 to 20 conveyor modules when these modules are not used (FIG. 3) as well as their transport to the usage site.

The 24 Vcc electrical energy passes from conveyor to conveyor thanks to an electrical connection at each end of the conveyor modules.

Particularly in exterior applications, the conveyor modules may be stacked in a motor vehicle to be transported to the vehicle loading or unloading site. The low-voltage electrical power needed for the conveyor modules can then be provided by the battery of the motor vehicle.

Technical Description

Terminology:

In the remainder of the document, the term “conveyor module” designates a complete module comprises different sub-assemblies such as the frame (1), the conveyor (36), . . . .

The term “conveyor” will be used to designate the sub-assembly of the “conveyor module” devoted exclusively to the conveying function.

In the appended drawings, provided as a non-exhaustive example of one embodiment of the invention:

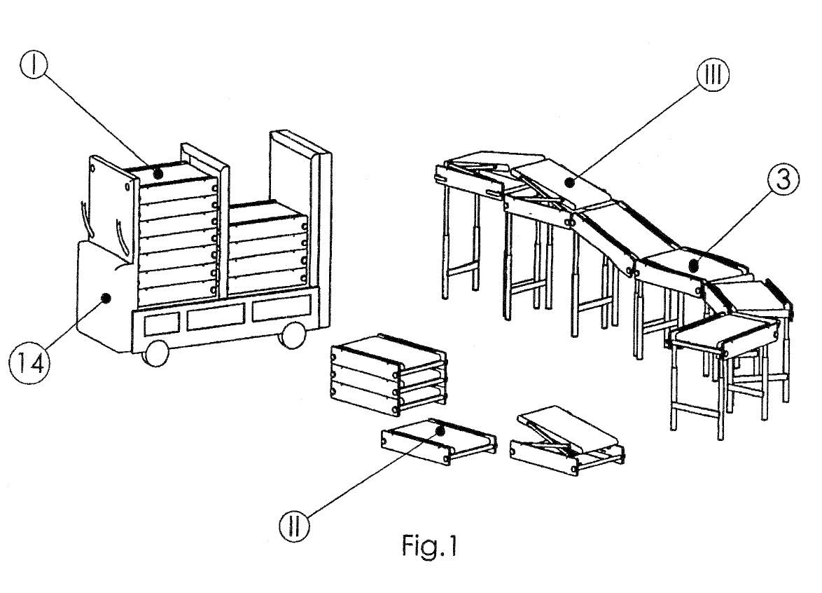

FIG. 1 shows a perspective view of the device according to the present invention making it possible to produce different conveyor circuit forms. The conveyor modules (3) are shown loaded on the carriage 14 (reference I), in their position while waiting for use (reference II), and in their unstacked position of use (reference III);

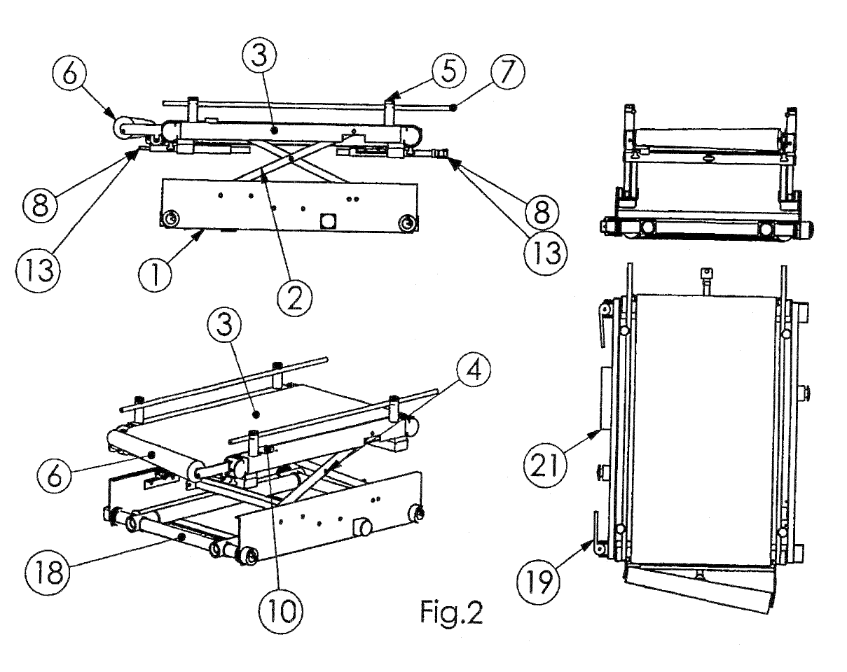

FIG. 2 shows a perspective view-as well as three two-dimensional views—of a first embodiment of the device according to the present invention, illustrating a conveyor module (3);

FIG. 3 shows a diagrammatic side view of the electrical power carriage;

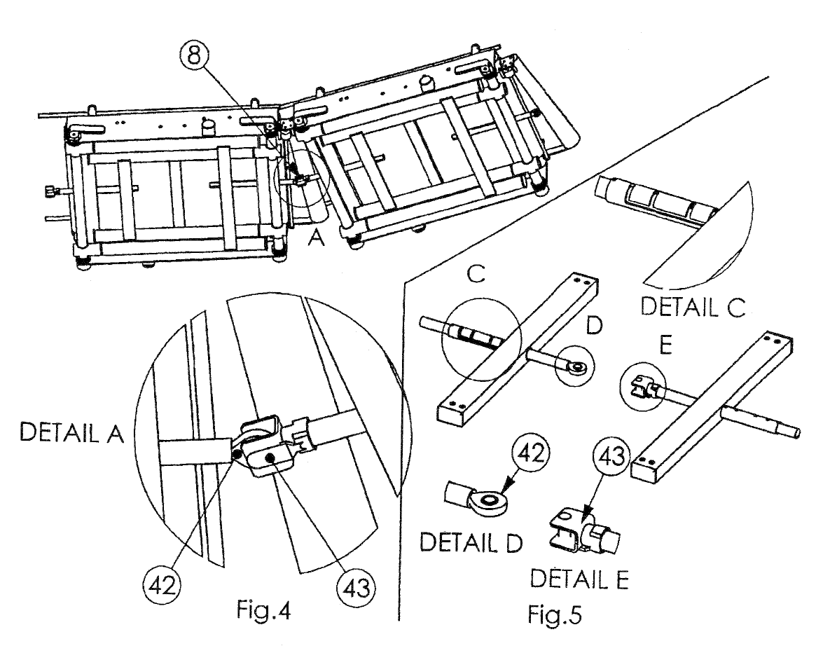

FIGS. 4 and 5 show one of the embodiments of the mechanical linking device between two portable conveyors. FIG. 4 is a bottom view of two conveyor modules (3). Detail A shows the mechanical link thanks to the ball joint and yoke system.

FIG. 5 more precisely shows this isolated device: detail C shows the telescopy system, identical for the male (ball joint 42) and female (yoke 43) system. Details D and E show an enlarged view of the ball joint (42) and the yoke (43);

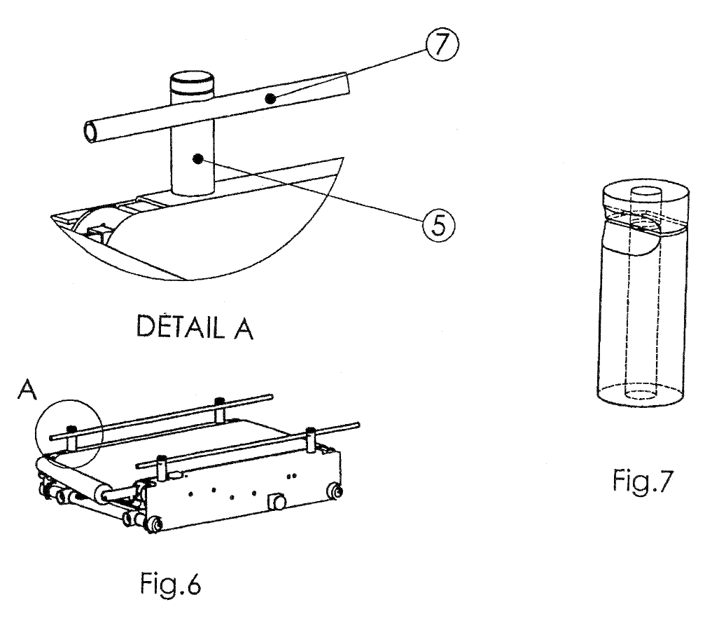

FIGS. 6 and 7 show one of the embodiments of the mechanical or magnetic guide edge support;

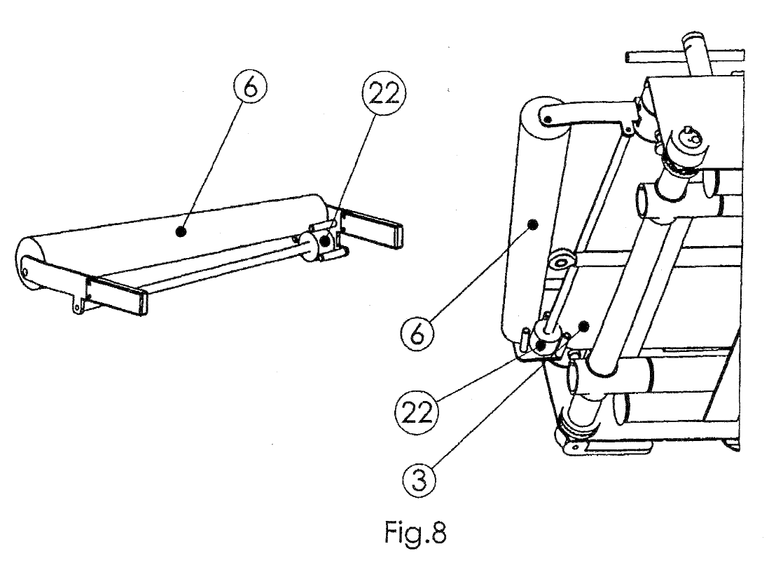

FIG. 8 shows one possible embodiment of the conical roller device 6 for transferring isolated loads between two portable conveyors;

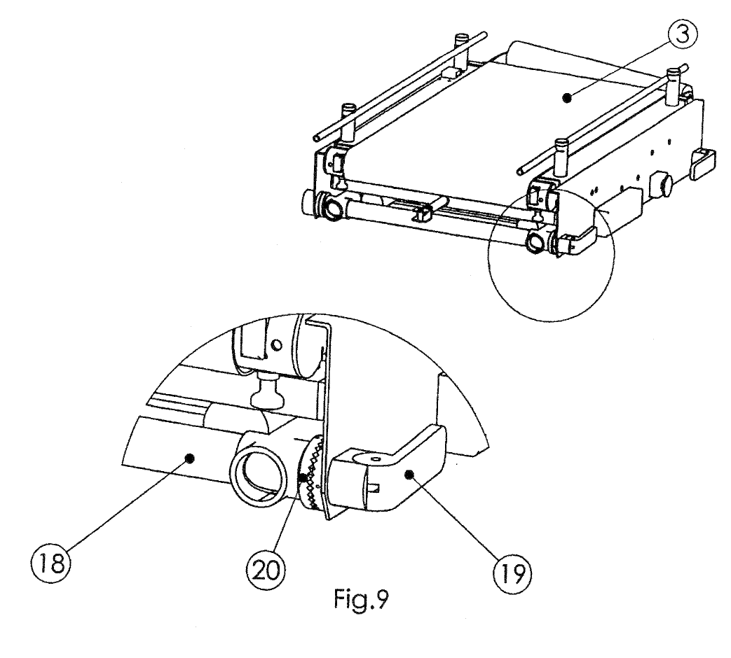

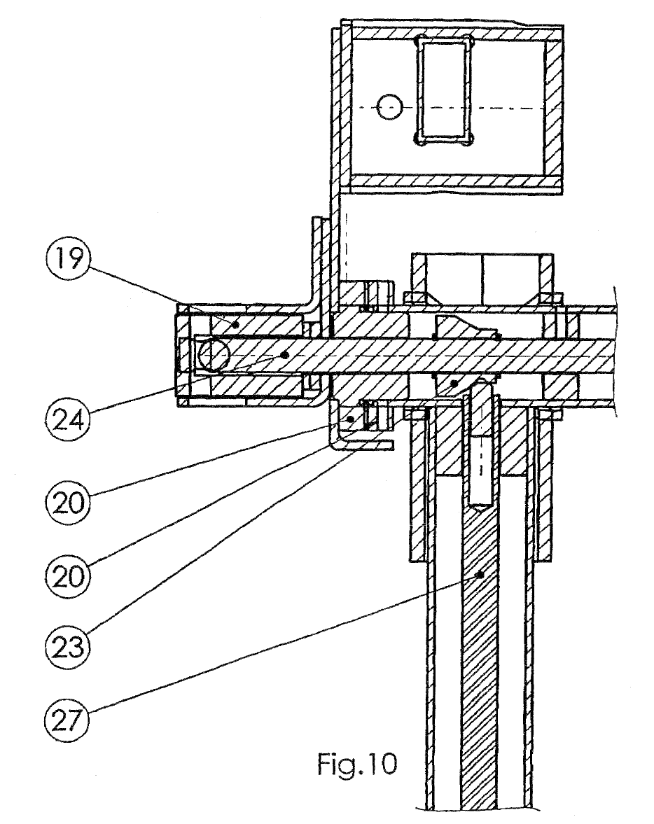

FIG. 9 shows one possible embodiment of the system for blocking the rotation of the telescopic legs;

FIG. 10 is a partial cross-section of the telescopic bipods (handle side);

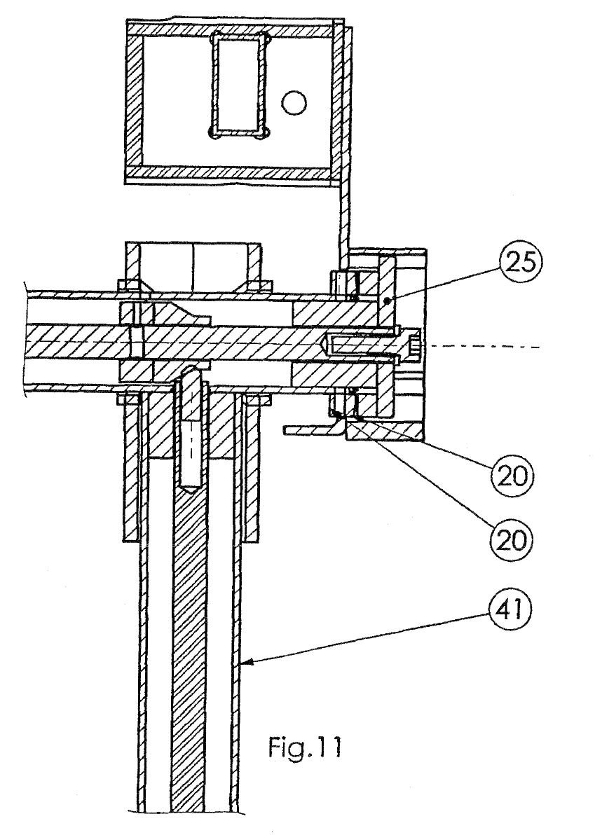

FIG. 11 is a partial cross-section of the telescopic bipods (side opposite the handle);

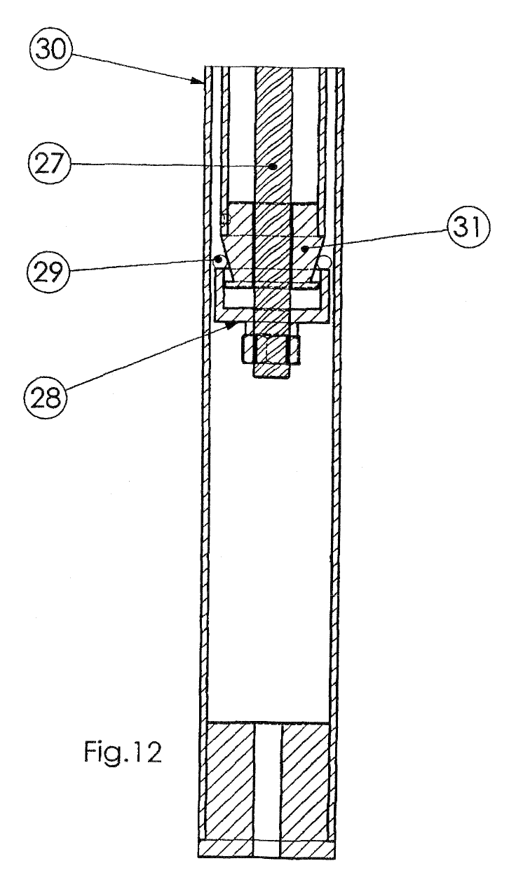

FIG. 12 is a partial cross-section of the blocking system at the top of the telescopic bipods;

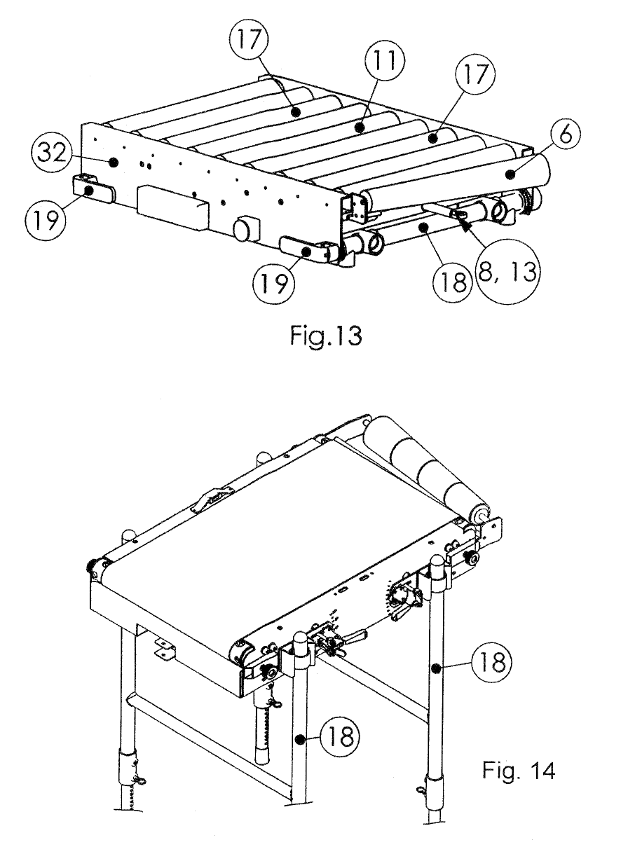

FIG. 13 shows one possible embodiment of a conveyor module with motorized rollers;

FIG. 14 shows another embodiment of a conveyor module.

The device for conveying isolated loads according to the present invention (FIGS. 1 to 13) is made up of an assembly of conveying modules (3) and a support and electrical power carriage (14), said device being intended to equip all installations for processing flows of merchandise (warehouses, sorting centers, factories, logistical centers, cargo terminals, etc.).

Each of the conveying modules (3) is made up of a frame (1), a continuous handling conveyor, height and inclination adjusting means (18) and (2), mechanical and electrical linking means (8) and (13) enabling the different modules to be disassemblably linked so as to form a route capable of causing the transported loads to follow straight and/or curved trajectories with adjustable inclinations thereby allowing changes in altitude, means (6) for transferring the transported load between the conveyor modules and means (5, 7) for guiding the transported load.

The height and inclination adjusting of each conveying module (3) will preferably be done using a system of retractable telescopic bipods (18).

The two telescopic bipods (18) can be completely retracted (in the horizontal position, they are completely integrated in the frame (1)), or, thanks to a rotational movement allowed by unblocking of the eccentric handle (19), may be oriented vertically or in an intermediate angular position between the horizontal and vertical positions.

Stopping the rotation of the bipods (18) is done thanks to toothed rings (20) which are held in engagement by the handle (19) (FIGS. 9, 10 and 11): the rotational movement of the handle (19) is transformed into translational movement by the eccentric shape of said handle (19) and transmitted to the horizontal tie rod (24). The control cones (23), fixed on the horizontal tie rod (24), transmit this movement to the vertical tie rods (27). The material used for the control cones (23) has good friction resistance (POM, PA, . . . ) so as to allow sliding of the end of the vertical tie rods on the control cones (23) during rotation of the bipods (18).

The length of each of the two bipods (18) (acting directly on the height of the conveying module (3)) can be adjusted thanks to a tubular guide rail: the male vertical posts (41) slide in the female vertical posts (FIGS. 11 and 12). Blocking in position is done through slicking of a ring spring (29) between the conical spring guide (31) and the female vertical post (30) (FIG. 12). During opening of the handle (19), the vertical post (27) descends and unsticks the spring (29), thereby freeing the telescopic movement of the guide (30, 41). In this way, opening the handle (19) simultaneously causes both rotational and telescopic unblocking of the bipod (18).

Inversely, its closing maintains the bipod (18) in an angular position and at a given height.

Direct action on the two handles (19) enables adjustment of the height and inclination of the portable conveyor, without tools.

The maximum inclination angle allowed by the height difference of the bipods (18) is 20° ad the maximum height of the load transport surface may be 1200 mm in relation to the ground.

This device may be completed by an elevation system (2) which makes it possible to increase the height and inclination adjustment route by elevating the conveyor relative to the frame (1). The elevation system (2) is preferably of the simple shear type (FIG. 2). In this way, the maximum inclination angle can be 25° and the additional height elevation approximately 300 mm. In this way, the maximum height of the load transport surface can reach 1500 mm in relation to the ground.

The conveying module (3) comprises mechanical connection means (8) and electrical connection means (13) at each of its ends so as to be able to be mechanically and electrically linked to the preceding and/or following module. Preferably, the mechanical linking means (8) are of the ball joint telescopic type (FIGS. 4 and 5) so as to be able to form, between the conveying modules, an angle that is variable over several planes. This is done so as to allow the assembly to have a route following a multidirectional trajectory (straight and/or curved, at different inclinations) for the flow of products to be transported (FIG. 1).

The mechanical linking device (8) is made up of a male part, the ball joint (42) (FIG. 5, detail D), and a female part, the yoke (43) (FIG. 5, detail E).

Each of these parts is telescopic so as to adapt to the different intervals created by the configuration of the installation: straight part towards another straight part, straight part towards a curved part, curved part towards a curved part.

The telescopy is adjusted by a 90° rotation of the yoke (43) or the ball joint (42) around its axis (FIG. 5, detail C). A torsion spring may be used to return to the initial position. Maintenance of the ball joint and the yoke in position is done thanks to a trunnion mounting (FIG. 5, detail E).

Preferably, the electrical linking means will be an electrical connector, ensuring the transmission of control signals (photocell and control information) and the supply of power (24 Vcc). This connector may be located under the telescopic device (8) so as to concentrate on a same intervention area of the user linking two modules.

The frame (1) is preferably designed to enable the conveying modules (3) to be stacked on top of each other when they are no longer in use (FIG. 1).

The continuous handling conveyor is of known technology: with rollers controlled by driving rollers, by a plastic-link belt or by a conveyor belt in a plastic or rubber material.

In the case of the controlled roller conveyor (FIG. 13), the latter part is preferably made up of a framework (32), a set of grooved free rollers (11), controlled by integrated rollers with electrical engines (17) (commonly called “driving motors”), and through round polyurethane bands positioned in relay between the rollers.

The transfer means (6) for the transported load between modules can be of the tapered roller type. The effect of the taper of the roller makes it possible to transport loads following a curved trajectory. Regardless of the conveying technology used, each of the conveying modules can be provided with such a motorized tapered roller (6) at each of its ends so as to cause the transported products to follow a curved trajectory.

This tapered roller (6) is motorized by powered by the conveyor belt of the conveyor through a counter roller (22) (FIG. 8). Each tapered roller (6) is mounted on a telescopic support enabling adaptation to the different gap lengths caused by the configuration of the installation, straight part to another straight part, straight part to curved part, curved part to curved part.

Moreover, motorized cylindrical rollers can be mounted instead and in place of tapered rollers when the user wishes to substantially increase the length of the concerned conveying module.

The guide means (7) of the transported load are preferably of the guide edge type, made up of a malleable tube in plastic or another material, which is fixed on a support (5) (FIG. 7), made so as to prevent transported products from falling on the ground.

This guiding edge device (7) is assembled on the different motorized conveyors (36) by mechanical and/or magnetic fixing (5) and thereby ensures continuous guiding over the entire conveying route, following all multidirectional trajectories (FIGS. 7 and 8).

The conveying modules can be provided with blockable wheels which allow easy and quick movement to the ground. These wheels are assembled at the end of the bipods (18). Optional clamps can be assembled around these wheels to allow the passage of stairs or changes in levels.

A set of photoelectric cells (10) and electronic control cards (21), loaded on the conveyor (FIG. 2), can grant the system accumulation operation without pressure.

The power carriage (14) (FIG. 3) comprises the power supply (15) able to be connected to any conveying module (3), as well as devices enabling the support of different conveyor accessories, at least:

guide edges (7) at site 33

tapered rollers (6) at site 39

cylindrical rollers for straight transfer at site 34

edge support (5) and emergency spare parts at site 38

. . . .

Wheels (40) can enable rolling movement of the carriage (14). The sites 37 can be used for resumption by carriage of the elevator or pallet truck type.

### EXAMPLE OF EMBODIMENT

The forms of implementation of the device according to the present invention are as follows: the user removes the conveying modules one by one from the power carriage (if this carriage is used, which is not mandatory) and places them on the ground to his liking.

He proceeds to adjust the height and inclination (thanks to two handles (19)) or curved trajectory by assembling the tapered transfer rollers (6).

He then mechanically and electrically connects the various portable conveyors to each other thanks to the devices (8) and (13).

Then, he connects the electrical power (from the carriage (14) or offset) to any of the conveying modules.

Lastly, he connects the carriage to the electrical network and pushes the on button for the electrical power: the conveyors then begin to operate according to the configured operating mode of the control card (21).

The system may operate according to several different operating modes:

an operating mode for accumulation without pressure,

a simple transport operating mode.

Operating modes can be changed very easily thanks to the adjustment of the paths on the control card (21) for each conveying module.

The implementation of various component elements gives the object of the present invention a maximum number of useful effects which to date have never been obtained through the existing devices.

It goes without saying that the invention is not limited to the embodiment described above but that it extends to all embodiments covered by the appended claims. Thus, as shown in FIG. 14, the upper ends of the legs 18 can be connected to the exterior surfaces of the case comprised by the module. In the illustrated example of one embodiment, these exterior surfaces comprise gripping members for receiving the upper ends of the legs 18, jaws of these gripping members being movable between a separated position, in which they allow the introduction of an upper end of a leg 18 between them, or the removal of this end, and a closer position, in which they squeeze this upper end between them. The jaws may be moved in particular using a rapid actuation system, of the type comprising three axes, known by the name “grasshopper”.

1. Device for conveying isolated loads comprising an assembly of conveying modules (3), characterized in that each of the conveying modules (3) is made up of a frame (1), a continuous handling conveyor, height and inclination adjusting means (18) and (2), and mechanical and electrical linking means (8) and (13) enabling the different modules to be linked so as to form a route capable of causing the transported loads to follow straight and/or curved trajectories with adjustable inclination.

2. Device for conveying isolated loads according to claim 1, characterized in that it comprises a support carriage (14) for the conveying modules (3) and/or electrical power for these modules (3).

3. Device for conveying isolated loads according to claim 1, characterized in that each conveying module (3) is provided with transfer means (6) between modules for transported loads following a curved trajectory.

4. Device for conveying isolated loads according to claim 1, characterized in that each conveying module (3) is provided with guide means (5, 7) for the transported loads.

5. Device for conveying isolated loads according to claim 1, characterized in that the height and inclination adjusting means (18) are produced through a system of telescopic and retractable bipods (18), each comprising angular blocking means (18) at the top of said bipod.

6. Device for conveying isolated loads according to claim 5, characterized in that the angular blocking means at the top of each bipod (18) are produced through the combination, on one hand, of an eccentric handle (19), four toothed rings (20), a horizontal tie rod (24), all positioned so as to angularly block the bipods (18) relative to the frame (1), and, on the other hand, of two control cones (23), two vertical tie rods (27), four vertical posts (30) and (41), two ring springs (29), positioned so as to block the height adjusting movement of the bipods (18).

7. Device for conveying isolated loads according to claim 1 characterized in that the additional height and inclination adjusting means (2) are of the simple shear type.

8. Device for conveying isolated loads according to claim 1, characterized in that the means (8) enabling a mechanical link between the different modules comprises telescopic expansion means with a ball link, positioned so as to be able to form a conveyor angle between the modules which is variable on several planes.

9. Device for conveying isolated loads according to claim 8, characterized in that the telescopic expansion means are adjustable without tools, by a 90° rotation of the ball joint (42) or of the yoke (43) around their axes.

10. Device for conveying isolated loads according to claim 1, characterized in that the means (6) for transferring transported loads between modules comprise a tapered roller, motorized thanks to a counter-roller (22) bearing on the rotating part of the conveyor, said tapered roller (6) being implemented so as to cause the transported products to follow a curved trajectory and being assembled on a telescopic support allowing adaptation to the different gap lengths caused by the configuration of the installation: straight part towards another straight part, straight part towards curved part, curved part towards curved part.

11. Device for conveying isolated loads according to claim 4, characterized in that the means (7) for guiding the transported loads comprise guide edges, made up of a malleable tube in plastic or another material, fixed on a mechanical or magnetic support (5), and positioned so as to prevent the transported products from falling on the ground.

12. Device for conveying isolated loads according to claim 1, characterized in that the mechanical and electrical linking means (8) and (13) are mounted on conveyors so as to be able to retransmit information signals as well as the electrical power needed for the connection to another conveyor module (3) located after a traditional conveyor, so as to be able to insert traditional conveyors within a circuit made up of conveying modules (3) according to the present invention.

13. Device for conveying isolated loads according to claim 1, characterized in that each conveying module (3) is designed to be portable and to be set up without tools, by only one person.

14. Device for conveying isolated loads according to claim 2, characterized in that each conveying module (3) is provided with transfer means (6) between modules for transported loads following a curved trajectory.

15. Device for conveying isolated loads according to claim 2, characterized in that each conveying module (3) is provided with guide means (5, 7) for the transported loads.

16. Device for conveying isolated loads according to claim 3, characterized in that each conveying module (3) is provided with guide means (5, 7) for the transported loads.

17. Device for conveying isolated loads according to claim 2, characterized in that the height and inclination adjusting means (18) are produced through a system of telescopic and retractable bipods (18), each comprising angular blocking means (18) at the top of said bipod.

18. Device for conveying isolated loads according to claim 3, characterized in that the height and inclination adjusting means (18) are produced through a system of telescopic and retractable bipods (18), each comprising angular blocking means (18) at the top of said bipod.

19. Device for conveying isolated loads according to claim 4, characterized in that the height and inclination adjusting means (18) are produced through a system of telescopic and retractable bipods (18), each comprising angular blocking means (18) at the top of said bipod.

20. Device for conveying isolated loads according to claim 2 characterized in that the additional height and inclination adjusting means (2) are of the simple shear type.
